(19) United States
(12) Patent Application Publication
(10) Pub. No.: US 2023/0159356 A1
(43) Pub. Date: May 25, 2023

(54) PRETREATMENT METHOD AND PRETREATMENT SYSTEM FOR DRAINAGE

(71) Applicant: NIPRO CORPORATION, Osaka (JP)

(72) Inventors: Michihito HIWATARI, Osaka (JP); Eiji SATOH, Osaka (JP)

(21) Appl. No.: 17/920,254

(22) PCT Filed: Apr. 20, 2021
(86) PCT No.: PCT/JP2021/016062

§ 371 Date: Oct. 20, 2022

(30) Foreign Application Priority Data
Apr. 24, 2020 (JP) 2020-077492

(51) Int. Cl. C02F 1/44

(52) U.S. Cl. CPC C02F 1/444; C02F 1/441; C02F 2103/34

(57) ABSTRACT

A pretreatment method is provided for efficiently recovering a solvent from a raw material mixture comprising water, the solvent and a polymer dissolved and/or dispersed therein.

The pretreatment method includes a step of subjecting the raw material mixture 12 to an ultrafiltration treatment 16, 18 to filter out the polymer so as to obtain a filtrate 36 of which polymer content is reduced.

### TECHNICAL FIELD

The present invention relates to a pretreatment method for a drainage. More particularly, the present invention relates to a method of the pretreatment for the drainage which contains a solid component. Specifically, this method can be carried out to pretreat the drainage as preparation for facilitating recovery of a useful component contained in the drainage.

### BACKGROUND ART

Drainages are produced from various manufacturing processes, and such drainages often contain useful components in addition to unwanted components. From viewpoints of the environmental protection and the product cost, it is desirable to recover and reuse such useful components.

For example, when a polymer material (for example, a polysulfone-based polymer) is dissolved in an appropriate solvent (for example, dimethylacetamide and water) to prepare a dope and hollow fibers are produced using the dope, a core liquid (for example, dimethylacetamide) and the dope are discharged together through a spinneret. The discharged dope is immersed in a coagulation bath where coagulation and phase separation of the discharged dope proceed so to form the hollow fibers.

In the process of manufacturing the hollow fibers as described above, a drainage which contains the solvent and the core liquid is generated as a spinning drainage. It is preferable to recover and reuse the solvent and/or the core liquid contained in this drainage as useful components. For example, when recovering the useful components contained in and from the drainage, for example, a distillation operation is often used.

The distillation operation can recover a useful component such as a solvent and/or a core liquid with a high purity, so it is a useful treatment method for reusing the recovered useful component. However, the distillation operation involves a phase conversion, and an amount of the energy required for the phase conversion is generally large, which is not necessarily desirable from a viewpoint of the production cost and the environmental protection.

### PRIOR ART DOCUMENTS

### Patent Documents

Patent Document: Japanese Patent Kokai Publication No. 2016-30233

### SUMMARY OF THE INVENTION

### Problems to be Solved by the Invention

When the distillation operation is used as described above, a large amount of energy is required for treating the drainage, so it is necessary to provide an idea to reduce the required energy. Furthermore, if the drainage contains, in addition to the solvent and the core liquid, a high-boiling-point component or a solid component such as a polymer dissolved and/or dispersed therein, and the drainage is subjected to the distillation operation, such component(s) remains in a reboiler as a residual component. There is a high possibility that this residual component adheres to heat transfer tubes of the reboiler as scale and adversely affects the heat transfer.

Therefore, it is not necessarily preferable to subject the drainage to the distillation operation as it is, and it is desired to provide a new and useful method for recovering the useful components contained in the drainage as described above.

### Means for Solving Problems

Regarding the above problems, the present inventors have studied for a new method of recovering a useful component (for example, a solvent used for preparing a dope) from a drainage containing the useful component, for example, a drainage generated when hollow fibers are prepared, and found that the useful component can be efficiently recovered by subjecting the drainage to filtration as a pretreatment before subjecting it to the distillation operation.

In a first aspect, the present invention provides a method of pretreating a raw material mixture as a drainage which comprises water, a solvent and a polymer dissolved and/or dispersed therein, wherein the pretreatment method comprises the step of subjecting the raw material mixture to an ultrafiltration treatment so as to obtain a polymer-enriched concentrate and a filtrate. The filtrate obtained is substantially free from the polymer, so that it can be subjected to, for example, a distillation treatment high recovers the solvent.

In a preferred embodiment, the pretreatment method described above further comprises the step of subjecting the filtrate obtained by the ultrafiltration treatment to a reverse osmosis filtration treatment to obtain a water-depleted retentate. The retentate thus obtained can be subjected to, for example, a distillation treatment which recovers the solvent similarly to the above.

The pretreatment method as described above can be carried out as a pretreatment for example when recovering a solvent from a spinning drainage as the raw material mixture, which is produced in the production of hollow fibers. Accordingly, the present invention provides a method of manufacturing the hollow fibers wherein the raw material mixture produced from a spinning step comprises water, a solvent and a dissolved and/or dispersed polymer therein, the method comprising the step (1) of subjecting the raw materials to the ultrafiltration treatment to filter out the polymer to obtain a polymer-depleted filtrate as a filtrate mixture; and in a preferred embodiment, further comprising the step (2), after the step (1), of subjecting the filtrate thus obtained to a reverse osmosis filtration treatment to obtain a retentate which is a concentrated mixture depleted in water.

In a second aspect, the present invention provides a pretreatment system for a raw material mixture as a drainage comprising water, a solvent and a polymer dissolved and/or dispersed polymer therein, and the drainage pretreatment system comprises an ultrafiltration unit for filtering out the polymer from the raw material mixture to obtain a substantially polymer-free filtrate, and optionally a reverse osmosis filtration treatment unit for obtaining a water-depleted retentate from thus obtained filtrate.

### Effect of the invention

In the present invention, it is preferable to subject the filtrate obtained by the ultrafiltration treatment and/or the retentate obtained by the reverse osmosis filtration treatment to the distillation treatment. When the filtrate is subjected to the distillation treatment, an amount of scale caused by the polymer is greatly reduced, and the adverse effect due to the scale on the heat transfer can be suppressed because the filtrate contains substantially no polymer or a very little amount of the polymer even if any when compared to the original raw material mixture, so that an amount of the scale in the reboiler which supplies heat is greatly reduced. Furthermore, when the retentate is subjected to the distillation treatment, an amount of water contained in the retentate is greatly reduced compared with the original raw mixture or the filtrate from the ultrafiltration treatment, so that an amount of energy required in the distillation treatment can be saved.

### BRIEF DESCRIPTION OF DRAWING

FIG. 1 schematically shows a flow sheet of the pretreatment system for carrying out the pretreatment method according to the present invention;

### EMBODIMENTS FOR CARRYING OUT THE INVENTION

In order to recover a certain useful component(s) from the raw material mixture as a drainage, when a raw material mixture is subjected to a pretreatment followed by performing other treatment (such as a distillation treatment), the term “pretreatment” in the present invention means the above-mentioned pretreatment which makes such other treatment easier and/or more efficient.

In the present invention, the raw material mixture to be subjected comprises water, a solvent and a poiymer. The solvent has a boiling point higher than that of water, and the polymer has substantially no boiling point. The polymer usually exists as a solid component in the raw material mixtures, and when heated, tit does not evaporate but decomposes, and may be oxidized or carbonized depending on its environment. Such raw material mixture becomes more viscous as its solid content increases, which makes a filtration treatment of the mixture difficult.

In the present invention, the solvent may be, for example, dimethylformamide, N-methyl-2-pyrrolidone, dimethylacetamide, dimethylsulfoxide, and the like, and it is not limited thereto.

In the present invention, the polymer may be, but is not limited to, a cellulose or its derivative such as a cellulose acetate, a polymethylmethacrylate, a polyacrylonitrile, a polysulfone, a polyethersulfone, a polyvinylpyrrolidone, and the like. Such polymer may be dissolved or dispersed in the raw material mixture, or it may be dissolved and dispersed therein.

In the present invention, when the filtration treatment is carried out, regardless of the filtration manner to be used, the filtration performance generally deteriorates with the passage of time of the filtration treatment due to reasons such as clogging of the membrane. In this case, it is necessary to temporarily stop the filtration treatment and perform maintenance (for example, membrane cleaning, membrane replacement, etc.) to restore the filtration performance, and thereafter the filtration treatment is restated. If the raw material mixture to be treated is being produced even while the filtration process is stopped, it is necessary to treat also the raw material mixture generated during that period after restating the filtration treatment.

In this case, when the capacity of a holding tank for the raw material mixture and the filtration performance after restarting are sufficient, the filtration can be carried out using a single system of the filtration unit. On the other hand, when the holding tank capacity and/or the filtration performance are insufficient, multiple systems of the filtration unit are used, and the filtration treatment is continued by switching one system to other system while maintenance is performed on said one system. Two or more systems of the filtration unit may be used depending on the maintenance time, the filtration capacity, the holding tank capacity, and the like.

In the present invention, the ultrafiltration treatment is a treatment which is generally called UF filtration. The filtration membrane used for the ultrafiltration may be in any suitable form, and it may be in the form of a flat membrane or a hollow fiber membrane. Moreover, when using the flat membrane, a filtration module haying it may be of a pleated type or a spiral type. When the hollow fiber membrane is used, the filtration module containing it is usually tubular. In accordance with the present invention, the ultrafiltration unit comprises such filtration module.

This ultrafiltration treatment yields a filtrate as a permeate and a concentrate as a concentrated mixture having a polymer content which is higher than that of the polymer contained in the raw material mixture to be treated. In this ultrafiltration treatment, substantially no polymer as the solid component passes through the filtration membrane to the filtrate side, and thus the filtrate comprises the solvent and water. The polymer content of the concentrate is preferably high, preferably at least 20 times, more preferably at least 40 times, particularly preferably at least 50 times, most preferably at least 60 times, such as 70 times as large as the polymer content of the raw material mixture. By carrying out the ultrafiltration treatment so as to achieve such a high concentration ratio, most of the solvent and the water contained in the raw material mixture can be obtained as the filtrate.

In a particularly preferred embodiment of the present invention, the ultrafiltration treatment is carried out in a dead-end flow manner followed by a cross-flow manner. That is, the ultrafiltration treatment is performed by combining the dead-end flow manner and the cross-flow manner in series. Employing this combination facilitates obtaining the concentrates having a large polymer content as described above,

For example, the ultrafiltration treatment in the dead-end flow manner provides only the filtrate that passes through the filtration membrane such that the concentration ratio is preferably at least fivefold, more preferably tenfold, such as fifteenfold or more. When the polymer content in the concentrate reaches such a concentration ratio, switching to other ultrafiltration treatment in the dead-end flow manner so as to continue the filtration treatment while said concentrate is removed. The removed concentrate is subjected to the ultrafiltration treatment in the cross-flow manner. Then, the ultrafiltration is performed such that the concentration ratio is preferably at least twofold, more preferably at least fourfold, and particularly preferably at least fivefold, which results in a filtrate that permeates the filtration membrane and a concentrate having a polymer content increased with such a concentration ratio.

In the dead-end flow manner, the raw material mixture is continuously supplied to the filtration unit, and only the filtrate is continuously taken out while the concentrate that does not permeate the membrane is accumulated. At the stage when the polymer content of the concentrate reaches the concentration ratio as described above, the ultrafiltration treatment reaches out by switching the ongoing system of the ultrafiltration unit to, for example, other system of the ultrafiltration unit. Therefore, when the filtration treatment is performed in this type of manner, it is preferable to use, for example, at least two systems of the ultrafiltration unit. For example, one system of the filtration unit performs the filtration treatment while the other system of the filtration unit receives the maintenance such as the removal of the accumulated concentrate and cleaning of the filtration membrane.

By using a plurality of systems of the filtration unit in this way, the ultrafiltration treatment can be carried out continuously. If the holding capacity of a tank for the raw material mixture is sufficient, and also the capacity of the filtration which is to be carried out thereafter is sufficient, a single system of the ultrafiltration unit may be used as described above. In this case, the ultrafiltration treatment may be stopped and the concentrate is removed followed by doing the subsequent maintenance. The raw material mixture can be stored in a tank that holds the raw material mixture while the filtration treatment is stopped.

In the ultrafiltration process in the dead-end flow manner, when the polymer content of the concentrate increases as described above, the viscosity of the concentrate increases, so that it is not easy to continue the ultrafiltration in the dead-end flow manner so as to further increase the polymer content. Therefore, it is preferable to adopt the ultrafiltration in the cross-flow manner so as to carry out the ultrafiltration treatment substantially continuously. In the cross-flow manner, both of the permeate that passes through the filtration membrane and the retentate that does not pass through the filtration membrane are continuously taken out. Similarly to the dead-end flow manner, it is possible to have two systems of the filtration unit of the cross-flow manner under the consideration of the maintenance of the filtration unit. When a holding tank with a sufficient capacity is provided between the dead-end flow ultrafiltration unit and the cross flow ultrafiltration unit, the cross flow ultrafiltration unit may be of a single system. For example, the ultrafiltration in the dead-end flow manner is performed until the polymer content of a first concentrate is, for example, 5-20% by mass, preferably 7-15% by mass, more preferably 8-12% by mass, such as 10% by mass, after which the first concentrate is subjected to the ultrafiltration in the cross-flow manner.

By carrying out the ultrafiltration treatment in the two stages as described above, it is possible to obtain a concentrate with a high solids content of the polymer, for example at least 30% by weight, preferably 40% by weight, and more preferably 50% by weight. When the dead-end flow manner and the cross-flow manner are combined as described above, the polymer content in the concentrate can be increased more compared with when the ultrafiltration treatment is performed only by the dead-end flow manner and also the membrane life of the ultrafiltration unit can be extended. It is conceived that one possible reason for this is that membrane clogging is relatively suppressed in the cross-flow manner.

In the present invention, the reverse osmosis filtration treatment is generally bailed RO filtration. The filtration membranes used for the reverse osmosis filtration may be of any suitable form and may be in the form of a flat membrane or a hollow fiber membrane. Moreover, when using the flat membrane, the filtration module having it may be of a pleated type or a spiral type. When the hollow fiber membrane is used, the filtration module containing it is usually tubular. In accordance with the present invention, the ultrafiltration unit comprises such filtration module.

The filtrate produced by the ultrafiltration treatment is treated by this reverse osmosis filtration treatment to remove water from the filtrate to be treated. As for an amount of water to be removed, a substantial amount, preferably at least 40%, more preferably at least 60%, for example 65% of the water contained in the filtrate obtained by the ultrafiltration treatment is removed as a permeate. The permeate may contain a trace amount of the solvent, preferably 50 ppm or less, more preferably 20 ppm or less, even more preferably 10 ppm or less. The water-depleted retentate resulting from the reverse osmosis filtration process comprises the balance of the solvent and the water which are remaining.

The retentate obtained as described above may be subjected to a further treatment, for example a distillation treatment in order to recover the contained solvent with a high purity, for example as a bottom product having a high boiling point. The bottom product can be recycled to and reused, for example, in the spinning step when necessary. On the other hand, in such distillation treatment, water including the solvent of a small content can be recovered as a distillate product having a low boiling point. The distillate product may optionally be subjected for example to the reverse osmosis filtration treatment together with the filtrate produced by the ultrafiltration treatment when necessary.

In a particularly preferred embodiment of the present invention, the reverse osmosis filtration treatment is carried out in a cross-flow manner. In this manner, the filtrate to be treated is continuously supplied to the filtration unit, and both of the retentate that does not permeate the filtration membrane and the permeate that permeates the filtration membrane are continuously taken out. When the performance of the filtration membrane has deteriorated, it is preferable, in order to clean the filtration membrane, to switch to other system of the reverse osmosis filtration unit and perform the reverse osmosis filtration treatment in the same manner. Therefore, at least two systems of the reverse osmosis filtration units are required for this manner of the reverse osmosis filtration treatment. For example, one system of the filtration units performs the filtration treatment while the other system of the filtration units receives the maintenance such as cleaning of the filtration membrane.

By using a plurality of systems of the filtration units in this way, the reverse osmosis filtration treatment can be performed continuously. When the holding tank capacity and/or the filtration performance are sufficient as described above, a single system of the reverse osmosis filtration unit may be used. In this case, the reverse osmosis filtration treatment may be stopped and thereafter its maintenance may be carried out. The permeate of the ultrafiltration treatment can be stored in the tank that holds the permeate while the filtration treatment is stopped.

In one preferred embodiment of the present invention, the raw material mixture comprising water, a solvent and a polymer is a drainage water produced in in the step of the hollow fiber spinning. This drainage water contains water as a main component (for example, 95% or more) and a solvent (for example, polyacetamide) as the balance (for example, several percent), and usually contains a small amount (for example, 1% or less) of a polymer (for example, polysulfone) dissolved and/or dispersed in the raw material mixture. It is desirable to recover and reuse the solvent from the view points of the environmental and the production cost.

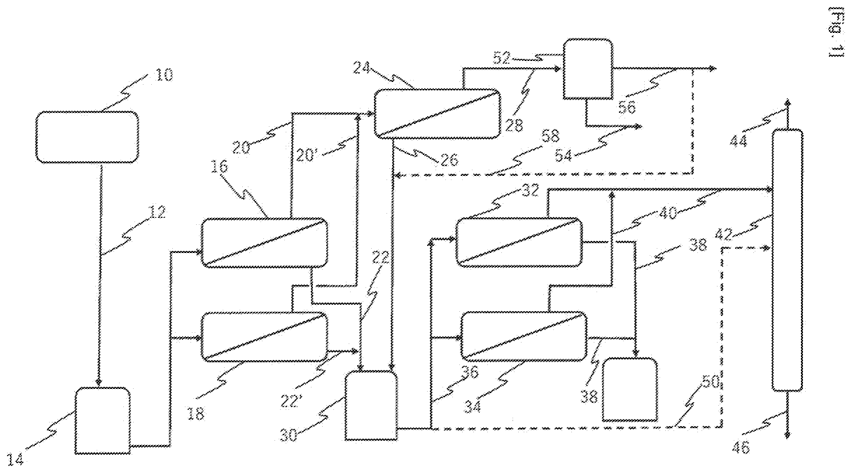

Embodiments for carrying out the pretreatment of the present invention will now be described in detail with reference to the accompanying drawing. FIG. 1 schematically shows a flow sheet of a raw material mixture pretreatment system. In the illustrated embodiment, the ultrafiltration treatment is carried out with two systems of the dead-end flow ultrafiltration unit to which a single system of the cross-flow ultrafiltration unit is connected in series, and the filtrate resulted from the ultrafiltration treatment is treated by the reverse osmosis filtration with two systems of the reverse osmosis filtration unit. That is, the raw material mixture is filtered in the two stages of the ultrafiltration treatment to obtain the filtrate, and thus obtained filtrate is treated with the reverse osmosis filtration. In the shown embodiment, the ultrafiltration treatment is carried out by alternately switching the two systems of the dead-end flow filtration unit in the first stage, and also carried out by supplying the resulted concentrate to the cross-flow filtration unit in the second stage so as to obtain a filtrate and a concentrated mixture.

The raw material mixture 12 produced in the spinning step 10 contains water, a solvent and a polymer as a solid content, and is stored in a tank 14 for holding the raw material mixture. This raw material mixture is pretreated using the pretreatment method according to the present invention. The raw material mixture accumulated in the tank 14 is supplied to one of the systems 16 of the ultrafiltration unit to perform the dead-end ultrafiltration treatment as the first-stage ultrafiltration treatment. In the illustrated flowsheet, the other system 18 of the ultrafiltration unit is also provided, so that totally two systems of the ultrafiltration unit are provided. By switching the ultrafiltration unit between them, the ultrafiltration treatment can be carried out in the dead-end flow manner.

More specifically, the dead-end flow ultrafiltration treatment is performed in one system 16 to obtain a filtrate. This filtration treatment can yield a first concentrate 20 which contains most of, preferably substantially all of the polymer contained in the raw material mixture along with the solvent and water, as well as a first filtrate 22 containing the solvent and water and not containing these removed into the first concentrate. The polymer content of the first concentrate is considerably greater than that of the polymer content of the raw material mixture (for example, 0.5-1.0% by weight), and it is for example 15 times as large as the polymer content of the raw material mixture. At the timing when the filtering capacity becomes insufficient as the filtering treatment progresses, the filtering treatment is continued by switching the system 16 to the other system 18 of filtering unit so as to similarly obtain a first concentrate 20′ and a first filtrate 22′. During this period, the removal of the concentrate from the system 16 of the filtration unit and its cleaning are performed followed by maintaining the system as required for the next filtration treatment. By providing two systems 16 and 18 of the filtering unit as described, the raw material mixture can be continuously filtered.

The first concentrate 20 (or 20′) thus produced by the ultrafiltration treatment in the dead-end flow manner is supplied to the ultrafiltration unit 24 in the cross-flow manner, and is subjected to the second-stage ultrafiltration treatment. This treatment yields a second filtrate 26 that permeates the membrane and a second concentrate 28 as a concentrated mixture. The second concentrate has an even greater polymer content, for example 5 times as large as that of the first concentrate. An amount which corresponds to the difference in an amount between the first concentrate 20 and the second concentrate 28 permeates the membrane to form the second filtrate 26, which comprises water and the solvent. In the illustrated embodiment, the first filtrate and the second filtrate are stored in a filtrate holding tank 30.

The first filtrate and the second filtrate obtained as described above are substantially free from the polymer and contain water and the solvent, and they are subjected to the osmosis filtration treatment as the filtrates obtained by the ultrafiltration treatment. In the illustrated embodiment, the reverse osmosis filtration treatment is carried out in two systems of the filtration units arranged in parallel and switchable as described above. While one system carries out the filtration treatment, the other system can receive required maintenance (including cleaning of the filtration membrane). Two systems 32 and 34 of the reverse osmosis filtration unit are used for the reverse osmosis filtration treatment. When pretreating the raw material mixture described above, the ultrafiltration treatment has transferred substantially all of the polymer to the concentrate side, so that the filtrate 36 supplied to the reverse osmosis filter unit 32 (or 34) is formed through the reverse osmosis treatment into water as the permeate 38 which may contain a small amount of the solvent as well as the remainder as the retentate 40.

By the reverse osmosis filtration treatment, an amount of water contained in the filtrate can be removed into the permeate 38 to obtain the retentate 40 with an increased solvent concentration. For example, a filtrate 36 having a solvent concentration of 2 to 3% by mass is subjected to the reverse osmosis filtration treatment to obtain a retentate 40 containing a solvent of 5 to 10% by mass. Due to the mechanism of the ultrafiltration treatment, an amount of the polymer in the filtrate if any is extremely small, so the retentate obtained by the reverse osmosis filtration treatment also contains a very small amount of the polymer.

Therefore, when the resulted retentate 40 is subjected to a distillation treatment 42 to recover the solvent, water with a low boiling point and the solvent accompanied thereby are produced as a distillate product 44 while a bottom product 46 is discharged which contains a large amount of the solvent with a high boiling point, and which is preferably substantially water-free (for example, a bottom liquid of the distillation unit). The bottom product is substantially free from the polymer and is suitable for reuse in the spinning step 10. Also, since the polymer does not enter the distillation system, the scale problem derived from the polymer in the reboiler used for distillation is substantially eliminated. It should be noted that the distillate product 44 (for example, an overhead distillate product of the distillation unit) contains the solvent and water, and may be recycled, for example, to the reverse osmosis filtration treatment, and the water contained in the distillate product may be transferred to the permeate 38 side.

It is noted that since the filtrate obtained by the ultrafiltration treatment contains substantially no polymer, it may directly be subjected to the distillation treatment unit 42 from the holding tank 30 as indicated by the dashed line 50 without being subjected to the reverse osmosis filtration treatment. In this case, there is no energy advantage since no water is removed from the filtrate by the reverse osmosis filtration treatment, but the scale problem in the reboiler used for the distillation may be avoided.

In addition, the concentrate 28 obtained by increasing the polymer content by the ultrafiltration treatment (for example, increasing the concentration ratio up to 50 times) is small in its absolute amount, and contains, as the solid content, substantially all of the polymer in the raw material mixture. When such concentrate is supplied to a solid-liquid separation unit 52 so as to perform solid-liquid separation into a solid component 54 containing the polymer and a remaining liquid component 56. When necessary, the liquid component 56 can be supplied to the holding tank 30 as indicated by the dashed line 58 and fed with the filtrate 36 to the reverse osmosis filtration treatment. The solid component 54 can be discarded or incinerated after an appropriate treatment as required.

### EXAMPLE

The present invention will be described in more detail below with reference to examples, but the present invention is not limited to such examples.

A spinning drainage as a raw material mixture, which was produced during spinning of the hollow fibers for dialyzers, was pretreated. The spinning drainage contained, for example, dimethylformamide (for example, 3 to 5% by mass) as a solvent, a cellulose acetate (for example, 0.5 to 1.2% by mass) as a solid content, in addition to water.

The raw material mixture 12 is supplied to ultrafiltration units 16, 18 in the dead-end flow manner to produce a first concentrate 20, 20′ having a solid content of 10% by mass and a first filtrate. 22, 22′substantially free from a solid component were obtained. The first concentrate was supplied to an ultrafiltration unit 24 in the cross-flow manner to obtain a second concentrate 28 as a concentrated mixture having a solid content of 45% by mass and a second filtrate 26 substantially free from a solid component. This second concentrate was supplied to a solid-liquid separator 52 where it was separated into a solid component and a liquid component.

The first filtrate and the second filtrate stored in the filtrate holding tank 30 were supplied to the reverse osmosis filtration units 32 and 34 as a filtrate 36 to obtain a retentate 40 having a solvent concentration of 5 to 10% by mass, and the rest was recovered as the permeate 38. An amount of the solvent contained in the permeated liquid was very small, for example, 10 ppm or less.

### INDUSTRIAL APPLICABILITY

The pretreatment method and pretreatment apparatus according to the present invention are effective means that can be implemented prior to the step of actually recovering the solvent upon recovering the solvent from a mixture containing water, a solvent and a polymer, so that the recovery of the solvent is facilitated.

### DESCRIPTION OF SYMBOLS

10 . . . spinning step
12 . . . raw material mixture
14 . . . raw material mixture holding tank
16, 18 . . . ultrafiltration unit in dead-end flow manner
20, 20′ . . . first concentrate
22, 22′ . . . first filtrate
24 . . . ultrafiltration unit in cross-flow manner
26 . . . second filtrate
28 . . . second concentrate as concentrated mixture
30 . . . filtrate holding tank
32, 34 . . . reverse osmosis filtration unit
36 . . . filtrate
38 . . . permeate liquid
40 . . . retentate liquid
42 . . . distillation treatment
44 . . . distillate product
46 . . . bottom product
50 . . . line for supplying filtrate directly to distillation treatment
52 . . . solid-liquid separator
54 . . . solid content component
56 . . . liquid component
58 . . . line for supplying liquid component from solid-liquid separator to filtrate holding tank

1. A method of pretreatment for a raw material mixture as a drainage comprising water, a solvent and a polymer dissolved and/or dispersed therein, comprising:
subjecting the raw material mixture to an ultrafiltration treatment to filter out the polymer so as to obtain a filtrate of which polymer content is reduced.

2. The pretreatment method according to claim 1, wherein the ultrafiltration treatment is performed in a dead-end flow manner and a cross-flow manner.

3. The pretreatment method according to claim 2, wherein the ultrafiltration treatment in the dead-end flow manner treatment produces a concentrate having a solid content of 5-20% by mass.

4. The pretreatment method according to claim 1, wherein the raw material mixture is a drainage discharged from a hollow fiber spinning step.

5. The pretreatment method according to claim 1, further comprising subjecting, after the ultrafiltration treatment, the obtained filtrate to a reverse osmosis filtration treatment so as to obtain a retentate of which water content is reduced.

6. A pretreatment system of a raw material mixture as a drainage comprising water, a solvent and a polymer dissolved and/or dispersed therein, comprising:
an ultrafiltration unit for filtering out the polymer from the raw material mixture to obtain a filtrate of which polymer content is reduced; and
a reverse osmosis filtration treatment unit to obtain, from the obtained filtrate, a retentate of which water content is reduced.

7. The system according to claim 6, configured to implement a pretreatment method including:
subjecting the raw material mixture to an ultrafiltration treatment to filter out the polymer so as to obtain a filtrate of which polymer content is reduced; and
subjecting, after the ultrafiltration treatment, the obtained filtrate to a reverse osmosis filtration treatment so as to obtain a retentate of which water content is reduced.

8. The pretreatment method according to claim 2, wherein the raw material mixture is a drainage discharged from a hollow fiber spinning step.

9. The pretreatment method according to claim 3, wherein the raw material mixture is a drainage discharged from a hollow fiber spinning step.

10. The pretreatment method according to claim 2, further comprising subjecting, after the ultrafiltration treatment, the obtained filtrate to a reverse osmosis filtration treatment so as to obtain a retentate of which water content is reduced.

11. The pretreatment method according to claim 3, further comprising subjecting, after the ultrafiltration treatment, the obtained filtrate to a reverse osmosis filtration treatment so as to obtain a retentate of which water content is reduced.

12. The pretreatment method according to claim 4, further comprising subjecting, after the ultrafiltration treatment, the obtained filtrate to a reverse osmosis filtration treatment so as to obtain a retentate of which water content is reduced.
